(19) United States
(12) Patent Application Publication
(10) Pub. No.: US 2008/0201780 A1
(43) Pub. Date: Aug. 21, 2008

(54) Risk-Based Vulnerability Assessment, Remediation and Network Access Protection

(75) Inventors: Shafqat U. Khan, Lynnwood, WA (US); Samoil Samak, Bellevue, WA (US); Khuzaima Iqbal, Issaquah, WA (US); Gopal Parupudi, Sammamish, WA (US); Muki Murthy, Sammamish, WA (US); Bryan R. Keller, Snoqualmie, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/677,001

(22) Filed: Feb. 20, 2007

(51) Int. Cl. G06F 11/00

(52) U.S. Cl. 726/25

(57) ABSTRACT

A system administrator may define a vulnerability and vulnerability setting for the client machine and may associate a level of risk with the vulnerability. The client may assess the level of risk associated with the vulnerability setting on the client machine and may report data regarding the level of risk to the system administrator.

### BACKGROUND

Any client machine in an enterprise of multiple client machines may have one or more vulnerabilities present that may affect the security of the machine or, more generally, the security of the enterprise. The vulnerability may be a weakness or security risk on the client machine and may be based on its configuration, the configuration of an application on the machine, the configuration of hardware or network settings, the presence or absence of certain applications and their updates, and so forth. The vulnerability may be manifest as a vulnerability setting, such as a configuration setting, for a client machine which may render the client machine vulnerable to a certain level of security risks.

Current tools are available in configuration management and monitoring space that allow an administrator to monitor whether a particular machine has such a vulnerability, but these tools are generally only indicate the presence or absence of a vulnerability.

### SUMMARY

Implementations of the present disclosure include a method of assessing risk on a client computing device managed in an enterprise by a system administrator. The method may include defining a vulnerability for the client computing device, defining a level of risk associated with the vulnerability, assessing the level of risk for the vulnerability on the client machine, and reporting data regarding the level of risk on the client computing device to the system administrator.

Also described are one or more computer-readable media that have executable instructions that, when executed, direct software to define one or more vulnerability settings, each vulnerability setting based on a vulnerability of a client computing device in an enterprise. The software may also define a level of risk associated with the vulnerability setting. The software may further associate a customized priority with the vulnerability setting and the level of risk, the customized priority being used for determining the importance of each vulnerability setting relative to other vulnerability settings. The software may then assess the overall level of risk in the enterprise associated with each vulnerability setting and customized priority.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a flow diagram for an exemplary method of defining and assessing a vulnerability, a vulnerability setting, and a level of risk.

FIG. 2 shows a flow diagram for an exemplary method of defining and assessing a vulnerability and a level of risk, and for prioritizing, based on the vulnerability, the nature of the client, and/or the level of risk.

FIG. 3 shows an exemplary system for assessing, prioritizing, and remediating one or more vulnerability settings based on one or more levels of risk.

### DETAILED DESCRIPTION

A system and method are described in which a system administrator may define and assess vulnerability for one or more clients in an enterprise based on a level of risk. Utilizing reports provided by the clients, the administrator may evaluate the risk of the vulnerability for the enterprise or a portion thereof. The system administrator may prioritize the vulnerabilities, levels of risk, and/or clients. The system administrator may also create new rules for customization to a particular enterprise or to a particular set of clients within the enterprise. While several examples are disclosed herein in the context of security in an enterprise, the techniques described are applicable to other fields or environments, such as non-security related vulnerabilities, non-enterprise groups, and so forth. Several exemplary systems and methods for analyzing vulnerability settings based on risk will now be described with more particularity and with reference to the drawings.

A vulnerability may exist or be created on a client machine that is part of an enterprise of multiple client machines managed or maintained by a system administrator. The system administrator may be a person, hardware, software program, or a combination of these in which a person interacts in some manner with software to manually or automatically maintain the client machines. The vulnerability may be a weakness or security risk on the client machine that may affect the security of the machine and/or the security of the enterprise. The vulnerability may be based on the client machine's configuration, the configuration of an application, the configuration of hardware or network settings, the presence or absence of certain applications and their updates, and so forth. A vulnerability setting may be a setting, such as a configuration setting, on the client machine the presence or absence of which may in some way expose the client machine to the vulnerability. The value of the setting may be any characteristic of the setting, such as a characteristic that increases or decreases the security of the setting. The value of the vulnerability setting may be used to determine whether the machine may be at high risk, low risk, or some level of intermediate risk with regard to the vulnerability.

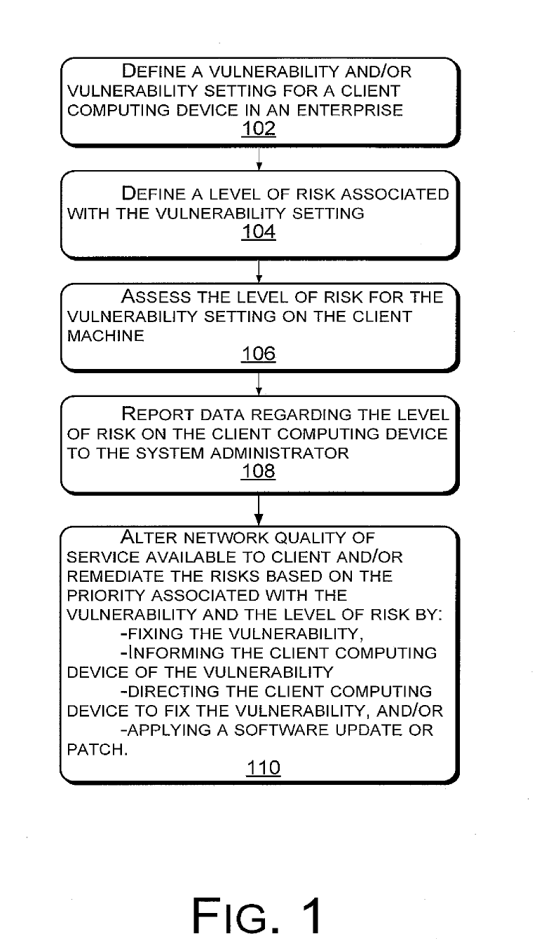

As illustrated by way of the flow diagram in FIG. 1, the system administrator may define the vulnerability settings (Block 102) and the rules to calculate the severity or level of risk (Block 104) based on the absence or presence and value of the vulnerability setting. The system administrator may determine that the absence of a particular vulnerability setting, i.e. a setting having no value, creates a high risk for a password vulnerability. The system administrator may define a client machine having some value for the vulnerability setting as low or lower risk. Additionally, the level of risk may be determined or defined based on the value of that setting. For example, the system administrator or engineer may deem a password setting having ten digits to be of lower risk than a password setting having only 5 digits. As another example, a setting to update a version of a program on a client machine daily may be determined to be of lower risk than a setting to update one time each calendar year. A setting to not update at all may be deemed an even higher risk for that vulnerability setting. The vulnerability settings and levels of risk may alternatively be defined and determined automatically by a program or program module or at least partially implemented by a program, such as through a security or setup wizard).

The system administrator or engineer may create or import level of risk rules to address particular, and often changing, scenarios and to tailor vulnerability analysis and remediation for a particular enterprise or for a group within the enterprise. For example, the system administrator may create one or more rules that define a vulnerability, a vulnerability setting, and/or a level of risk. The administrator may thereby adjust to new vulnerabilities and vulnerability settings (Block 102), and define additional risk levels (Block 104) for that particular enterprise of group within the enterprise. Having the ability to tailor the definitions, analysis, and/or remediation actions for each enterprise or group within the enterprise may provide a customized approach for clients with unique software, hardware, and/or security needs.

The system administrator may request or order one or more clients or client machines to assess one or more vulnerability settings and the level of risk associated with those vulnerability settings (Block 106). The client may perform a scan or other evaluation in order to determine the value and level of risk associated with each vulnerability setting.

The client may report the data regarding the assessment to the system administrator (Block 108). The client may undertake this reporting independently and voluntarily or may be directed to provide the report by the system administrator The report may be generated manually or automatically and may be performed periodically or as a single instance. The client may report on the setting by providing the setting value and/or may report its level of risk based on the vulnerability setting for that client and on the level of risk rules and definitions provided by the system administrator. The client may provide the report as raw data or in a spreadsheet, chart, or other appropriate reporting format. The reports may be reviewed individually for each client or the reports for various clients may be contained in a combined report for those various clients. The system administrator may use the reports to assess overall risk in the enterprise, or a portion of the clients in the enterprise, based on the severity of the risk associated with one or more vulnerability settings on those machines.

The system administrator may configure an appropriate remediation action and/or network access restriction based on the level of risk (Block 110). For example, the system administrator may analyze a reported level of risk to determine whether to alter the network quality of service for that client. For clients that are determined to be at a higher risk, the system administrator may reduce the network quality of service for that client by providing reduced bandwidth, giving limited access to the network for a period of time, or blocking network access altogether. Additionally or alternatively, the administrator may change the value of the vulnerability setting to reduce or eliminate the risk. The administrator may notify the client machine of the level of risk associated with vulnerability setting and/or may direct the client machine to change the vulnerability setting in order to reduce or eliminate the risk. The system administrator may also provide a patch, update, module, or other program to remediate the vulnerability.

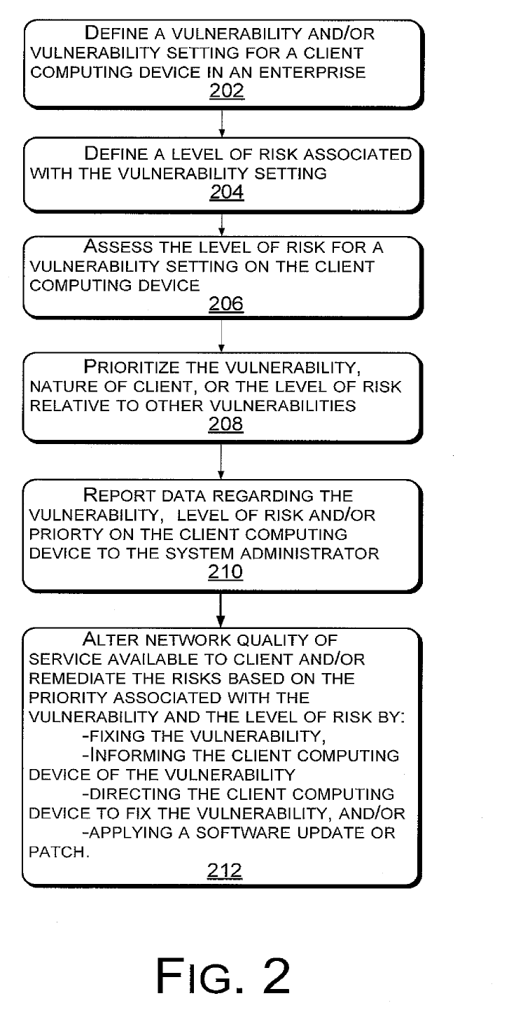

According to the implementation shown in FIG. 2, in addition to defining the vulnerability (Block 202) and level of risk (Block 204), and assessing the level of risk on the client machine (Block 206), as described above, each administrator may also define a weight, or priority, based on the level of risk, the vulnerability, and/or the nature of the client machine (Block 208). For example, higher level of risks may be prioritized over intermediate or low levels of risk. Additionally or alternatively, the system administrator may prioritize the vulnerabilities, e.g. prioritizing a password setting vulnerability over a version update setting vulnerability. Further, the system administrator may prioritize a client or group of clients based on the nature of that client or group of clients. For example, a client machine containing particularly sensitive or confidential information may be prioritized over a client machine containing little or no information that is sensitive or confidential to the enterprise. Client machines used by executives in a business enterprise may be prioritized over client machines used by staff members. The priority may even be based on a combination of these considerations. Thus, for example, an intermediate risk level for a password setting may be prioritized for remediation before a high risk for an update setting. Prioritizing allows the administrator to target remediation action based on the risks and vulnerabilities that are determined to be most important to the enterprise.

The priority may be determined at any time before or after the client machines report on the level of risk for each vulnerability setting (Block 210). Determining the priority before requesting the reports, as shown in FIG. 2, allows the system administrator to focus time and effort on collecting reports on those vulnerabilities with the highest priorities. Determining the priority after the client machines have reported on the levels of risk allows the system administrator to consider the frequency of a level of risk associated with a given vulnerability setting when setting the priority. Thus, a vulnerability setting, level of risk, and/or nature of client may be prioritized based upon the reported information.

The system administrator may configure an appropriate remediation action and/or network access restriction based on the level and/or priority of the risk (Block 212). For example, the system administrator may analyze a reported level of risk and prevent clients that are determined to be at a higher risk and/or priority from connecting to a network. Additionally or alternatively, the administrator may change the value of the vulnerability setting to reduce or eliminate the risk. The administrator may notify the client machine of the level of risk associated with vulnerability setting and/or may direct the client machine to change the vulnerability setting in order to reduce or eliminate the risk. The system administrator may also provide a patch, update, module, or other program to remediate the vulnerability.

The following example may be used to illustrate the implementations shown in FIGS. 1 and 2. An administrator may maintain a set of client machines in an organization in which the machines have a Structured Query Language (SQL) server application, such as Microsoft® SQL server available from Microsoft Corporation of Redmond, Wash., installed. To determine how secure the setting is for the SQL server passwords across all client machines in the organization, the administrator may define what an SQL server password setting looks like and how it can be detected. The administrator may define a risk level associated with a given value of password. For example, having an empty password may be tagged as a high risk. A weak password, such as one containing only alphanumeric characters, may be tagged as a medium risk. A strong password, containing a combination of alphanumeric and non-alphanumeric characters and/or upper and lower case characters may be considered to be of low risk or even no risk. Each client may report back to the server, and thus the system administrator, the level of risk associated with the password setting based on the rules defined for the setting.

Each administrator may also define a priority, or weight, associated with the level of risk for the SQL password setting. Thus, an empty password may be prioritized for remedial action before a weak password, and so forth.

The reports from each machine may be collected and reviewed by the system administrator to assess the severity of the SQL password vulnerability setting across the enterprise. The administrator may determine the number of machines at each risk level, and, more particularly, which machines have a password vulnerability setting at a level of risk that is of a higher priority relative other vulnerabilities and levels of risk. This allows the system administrator to determine the number of client machines having higher levels of risk and priority, and to remediate the risk and/or restrict network access for those machines first. In the case of a network access restriction, the system administrator may, for example, prevent a machine from accessing a particular network if an empty password is detected for that client machine.

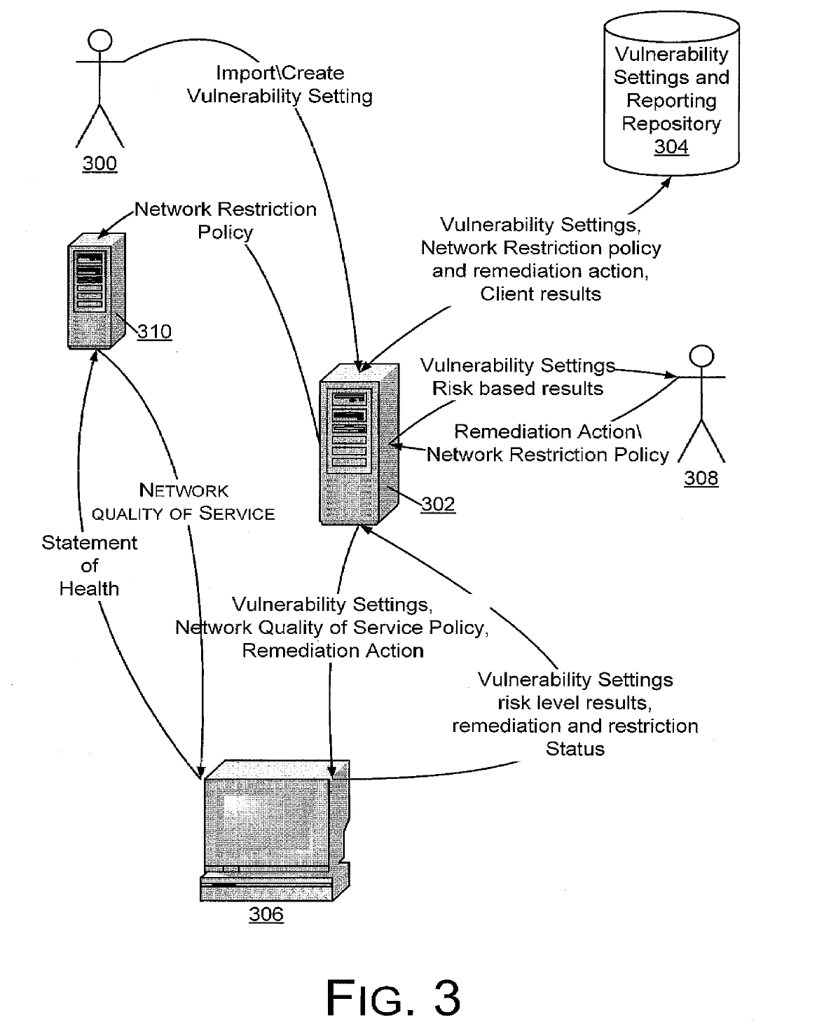

FIG. 3 shows a system for defining, assessing, and remediating risks associated with vulnerabilities on client machines. A system engineer 300 may import or create rules on a configuration management server 302 to define vulnerabilities, vulnerability settings, and levels of risks. The rules and vulnerability settings may be stored in a repository 304, which may be a database, for example. System Definition Models (SDMs) may be used to define and detect these settings on one or more clients 306 within the enterprise. The configuration management server 302 may route the results reported by the clients 306 to the repository 304 for storage. The configuration management server 306 may also receive requests to import\create new system definitions and may be responsible for storing such definitions into the repository 302. A system administrator 308 may maintain or control the configuration management server 306 and may review the reports to assess overall risk to an enterprise associated with each vulnerability setting.

The system administrator 308 may utilize the information gathered in the report to determine what remediation action to take and whether network restriction is necessary or appropriate. The configuration management server 302 may present the remediation action and/or network restriction policy defined for certain vulnerability settings to the targeted client 306 and or a network restriction server 310. The client 306 may determine which remediation action to perform based on the risk associated with the setting detected on the client 304. For example, if the remediation action to be taken is for the client to change the vulnerability setting, the system administrator may provide instructions for effecting the change in manner that reduces the risk. The client 306 may also use the network restriction policy sent by the configuration management server 302 and the local results for the vulnerability settings to generate a statement of health to send to the network access restriction server 310. The network access restriction server 310 may apply appropriate network restriction to the client 306 based on the statement of health and the policies received from configuration management server 306.

The system administrator 308 may create one or more definitions for new vulnerable configuration settings not created or imported by the system engineer 300. The system administrator may also define rules to calculate risk based on the value detected for the setting. These settings and the risk based determination are thereby logic extensible. These rules may be created and defined on configuration management server 302 and may be stored in repository 304. The system administrator may use Services Modeling Language (SML) to define the vulnerabilities. The system administrator 308, or an enterprise engineer 300, may add or import extensions in SML or otherwise define rules to determine risk associated with instances of settings detected on the client machine 304. One or more application programming interfaces (APIs) and/or user interfaces (UIs) may be utilized with the SML to allow the system administrator 308 to more easily define settings and create risk based rules for a setting. Any common engine used to detect instances of models defined using SML may also be used to detect instances of vulnerable configuration settings.

Once the one or more vulnerability settings along with risk-based rules have been imported into the system they are then passed to the managed client 304 to evaluate these settings on the client 304. The client 304 may detect the one or more settings using a common SML-based model evaluation and detection engine, which is well known to those skilled in the art. Once the one or more settings are detected, the risk-based rules are applied to determine the risk level. The client 304 then sends the risk level information to the configuration management server 306. The configuration management server 306 may present a set of UI(s) and API(s) to the administrator 308 so that the administrator 308 can associate custom severity with each vulnerability setting and also associate different priority levels to each risk level. The risk levels returned from clients for each vulnerability setting and the priority associated with that risk and vulnerability setting are used to determine the overall risk to the enterprise associated with each vulnerability. The administrator 308 may investigate each client 304 to see actual instances on that client 304 for each vulnerability setting to determine what action should be taken.

Once the administrator 308 has determined the overall risk associated with each vulnerability setting, the administrator 306 may pick the vulnerability with higher risk, and/or a higher designated priority, and determine an appropriate remediation action. The UI and API may allow the system administrator 308 to associate a particular action for each risk level or to a risk exceeding or below a certain risk level. The actions may involve executing a script, sending a notification message to a logged-on user, applying a configuration setting, or updating a vulnerable application, operating system, or hardware driver to a newer version. The one or more remediation actions, its association with a vulnerability setting, and its association to the risk level for that setting are stored in the system repository 304. A client to management point messaging infrastructure may be used to deliver these actions as policies. For example, the client 306 may receive instruction through the policies to apply certain action if a setting detected on that client 306 has a risk level higher than a certain value. If the setting has a risk higher than the one defined in policy, clients will perform the associated remediation action and report the status of the remediation action to configuration management server 302.

The administrator 308 may also define network restriction policies based on the risk associated with a vulnerability setting. For example, the administrator 308 may define a risk level for a particular vulnerability setting on a client 306 beyond which the system will not permit the client 304 connect to a network. Alternatively, the client 306 may be permitted limited access to, for example, a local area network, but not a wide area network or the Internet. These policies may be delivered to the client 306 through existing policy infrastructures. When the client 306 receives the network restriction based policies from the configuration management server 302, it may evaluate the risk associated with that setting. If the risk on that client is higher than the level defined in the network restriction policy, the client will generate an unhealthy statement of health for network access restriction server 310. The network access server 310 evaluates the statement of health and verifies the signature passed on by the client 304 for the network restriction policy having the network restriction policy signature published by the configuration management server 302. If the statement of health is “unhealthy” and the policy is to restrict network access for clients with an unhealthy statement of health, the client will be permitted limited or no network access.

While some of the techniques described herein are described as being performed by a system administrator or engineer, any of the techniques described herein may be implemented at least partially by a program and/or with the assistance of a program such as a security wizard program, setup wizard program, or the like.

Specifics of several exemplary methods are described above. However, it should be understood that certain acts in each method need not be performed in the order described, may be modified, and/or may be omitted entirely, depending on the circumstances.

Also, any of the acts described above with respect to any method may be implemented by a processor or other computing device based on instructions stored on one or more computer-readable media associated with the client machines. Computer-readable media can be any available media that can be accessed locally or remotely by the client machines. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the client machines.

### Conclusion

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method of assessing risk on a client computing device managed in an enterprise by a system administrator, the method comprising:
defining a vulnerability for the client computing device;
defining a level of risk associated with the vulnerability;
assessing the level of risk for the vulnerability on the client machine; and
reporting data regarding the level of risk on the client computing device to the system administrator.

2. A method according to claim 1, further comprising creating rules for defining the vulnerability and the level of risk.

3. A method according to claim 2, wherein the rules are defined or selected by the system administrator.

4. A method according to claim 1, further comprising prioritizing the vulnerability or the level of risk relative to other vulnerabilities and levels of risk.

5. A method according to claim 4, wherein the priority is determined before assessing the level of risk for the vulnerability on the client machine.

6. A method according to claim 4, wherein the priority is determined after reporting data regarding the level of risk on the client computing device to the system administrator.

7. A method according to claim 1, wherein the vulnerability is a software based vulnerability, a system setting vulnerability, or a hardware vulnerability.

8. A method according to claim 4, further comprising remediating the risks based on the priority associated with the vulnerability and the level of risk.

9. A method according to claim 8, wherein remediating the risks comprises:
fixing the vulnerability by adjusting a vulnerability setting,
informing the client computing device to fix the vulnerability by adjusting the vulnerability setting, or
applying a software update or patch or configuration script.

10. A method according to claim 1, further comprising altering the quality of network service available to the client computing device based on the risk level assessment.

11. A method according to claim 10, wherein the quality of network service is altered to prevent the client from accessing the network.

12. One or more computer-readable media comprising executable instructions that, when executed:
define one or more vulnerability settings, each vulnerability setting based on a vulnerability on a client computing device in an enterprise;
define a level of risk associated with the vulnerability setting;
associate a customized priority with the vulnerability setting and the level of risk, the customized priority for determining the importance of each vulnerability setting relative to other vulnerability settings; and
assess the overall level of risk in the enterprise associated with each vulnerability setting and the customized priority.

13. One or more computer readable media according to claim 12, further comprising executable instructions that, when executed, direct software to:
remediate the risk based on the customized priority associated with the vulnerability setting and the level of risk.

14. One or more computer readable media according to claim 12, further comprising executable instructions that, when executed, direct software to:
alter the quality of network service available to the client computing device based on the level of risk associated with the vulnerability setting.

15. One or more computer readable media according to claim 12, wherein the vulnerability is a software based vulnerability, a system setting vulnerability, or a hardware vulnerability.

16. A method according to claim 12, wherein the customized priority is determined after assessing the level of overall risk for the vulnerability in the enterprise.

17. A system comprising one or more modules that are configured to assess a level of risk associated with a vulnerability setting on a client computing device in an enterprise.

18. A system according to claim 17, wherein the vulnerability settings are defined by a system administrator using rules to calculate a level of risk based on the presence or absence of a vulnerability and predetermined aspects of the vulnerability.

19. A system according to claim 17, wherein the overall risk in the enterprise may be assessed based on the risk associated with the vulnerability setting on one or more client machines in the enterprise.

20. A system according to claim 17, further configured to:
prioritize the level of risk for the vulnerability setting relative to the levels of risk of other vulnerability settings; and
remediate the risks based on the customized priority associated with the vulnerability setting and the level of risk by:
adjusting the vulnerability setting,
informing the client machine of the vulnerability, or
applying a patch or update or configuration script for the vulnerability.
